(19) United States
(12) Patent Application Publication
(10) Pub. No.: US 2019/0372121 A1
(43) Pub. Date: Dec. 5, 2019

(54) COMPOSITIONS USEFUL FOR PRODUCING ELECTRODES AND RELATED METHODS

(71) Applicant: Cabot Corporation, Boston, MA (US)

(72) Inventors: Wei-Fu Chen, Westford, MA (US); Andriy Korchev, Westford, MA (US); Peter B. Laxton, Shanghai (CN); Katherine Mullinax, Northboro, MA (US); Qian Ni, Billerica, MA (US); Miodrag Oljaca, Concord, MA (US)

(21) Appl. No.: 16/420,684

(22) Filed: May 23, 2019

Related U.S. Application Data
(60) Provisional application No. 62/680,648, filed on Jun. 5, 2018.
(60) Provisional application No. 62/685,574, filed on Jun. 15, 2018.

(51) Int. Cl. H01M 4/62; H01M 4/525; H01M 4/505; H01M 4/1391

(52) U.S. Cl. CPC H01M 4/625; H01M 4/622; H01M 2004/028; H01M 4/505; H01M 4/1391; H01M 4/525

(57) ABSTRACT

Compositions that can be used in producing electrodes (e.g., battery electrodes) and related methods are disclosed. As one example, a composition, includes carbonaceous particles; a dispersant; a polymer comprising a maleic anhydride moiety; and a solvent. The carbonaceous particles can include carbon black, graphite, acetylene black, graphenes, graphenes-related materials, carbon nanotubes, carbon nanostructures, activated carbons, carbon aerogels, templated carbons, and/or carbon fibers.

### FIELD OF THE INVENTION

The invention relates to compositions that can be used in producing electrodes (e.g., battery electrodes) and related methods.

### BACKGROUND

Lithium-ion batteries are commonly used sources of electrical energy for a variety of applications, such as electronic devices and electric vehicles. A lithium-ion battery typically includes a negative electrode (e.g., graphite) and a positive electrode (described below) that allow lithium ions and electrons to move to and from the electrodes during charging and discharging. An electrolyte solution in contact with the electrodes provides a conductive medium in which the ions can move. To prevent direct reaction between the electrodes, an ion-permeable separator is used to physically and electrically isolate the electrodes. When the battery is used as an energy source for a device, electrical contact is made to the electrodes, allowing electrons to flow through the device to provide electrical power, and lithium ions to move through the electrolyte from one electrode to the other electrode.

The positive electrode typically includes a conductive substrate supporting a mixture (e.g., applied as a paste) having at least an electroactive material, a binder, and a conductive additive. The electroactive material, such as a lithium transition metal oxide, is capable of receiving and releasing lithium ions. The binder, such as polyvinylidene fluoride, is used to provide mechanical integrity and stability to the electrode. Typically, since the electroactive material and the binder are electrically poorly conducting or insulating, the conductive additive (e.g., graphite and carbon black) is added to enhance the electrical conductivity of the electrode. The conductive additive and the binder, however, are generally not involved in electrochemical reactions that generate electrical energy, so these materials can negatively affect certain performance characteristics (e.g., capacity and energy density) of the battery since they effectively lower the amount of electroactive material that can be contained in the positive electrode.

### SUMMARY

In one aspect, the invention features compositions that can be used to manufacture an electrode of a battery, such as, for example, by applying a composition and other materials to a conductive substrate to form a positive electrode of a lithium ion battery. In some embodiments, the compositions include carbonaceous particles that serve as a conductive additive, a dispersant, a polymer including a maleic anhydride moiety, and a solvent. Applicant has found that, in compositions used to make electrodes, certain carbonaceous particles, such as carbon black particles having high structure, serve very effectively as a conductive additive, but the carbonaceous particles can undesirably increase the viscosity of the compositions such that processing the compositions becomes difficult or impractical. One way to address high viscosity is to dilute the compositions, but dilution increases manufacturing costs and reduces throughput. To reduce or eliminate an unacceptable or undesirable increase the viscosity without diluting the compositions, Applicant uses a dispersant that interacts with the carbonaceous particles. The dispersant mitigates viscosity increases and allows the compositions to be made and use with relatively high concentrations of carbonaceous particles, which in turn maintains or lowers manufacturing costs, and maintains or increases production throughput. In certain embodiments, the dispersant is a cellulosic dispersant.

Additionally, Applicant has found that adding a polymer including a maleic anhydride moiety to the compositions (e.g., dissolved in the solvent) can enhance the performance (e.g., cycle life) of an electrode or a battery that was produced using the compositions. Without being bound by theory, it is believed that certain electroactive materials (such as lithium cobalt manganese oxides and lithium nickel cobalt aluminum oxides) deteriorate in performance because they are dissolved by hydrofluoric acid (HF). HF is created when LiPF₆ (a common material in a battery electrolyte) reacts with water that is generated when the battery is charged and the solvent of the electrolyte is oxidized. It is believed that the polymer including a maleic anhydride moiety is capable of reacting with or scavenging the water, thereby reducing or eliminating the production of HF and consequently dissolution of the electroactive materials. Additionally or alternatively, it is believed that the maleic anhydride moiety of the polymer transforms into a carboxylic acid moiety that reacts with lithium ions in the battery to form ionic channels at the solid-electrolyte interface at the electrode, thereby enhancing lithium ion transport and overall performance of the battery.

In another aspect, the invention features a composition, including: carbonaceous particles; a dispersant; a polymer including a maleic anhydride moiety; and a solvent.

In another aspect, the invention features a method, including combining carbonaceous particles, a dispersant, a polymer including a maleic anhydride moiety, and a solvent to form a composition.

In another aspect, the invention features a method, including combining an electroactive material with a first composition including carbonaceous particles, a dispersant, a polymer including a maleic anhydride moiety, and a solvent, to form a second composition; and using the second composition to make an electrode.

In another aspect, the invention features a composition, consisting essentially of: carbonaceous particles; a dispersant; a polymer including a maleic anhydride moiety; and a solvent.

In another aspect, the invention features a composition, consisting essentially of: carbon black particles, a cellulosic dispersant, and a solvent including N-methylpyrrolidone.

In another aspect, the invention features an electrode, including: carbonaceous particles; a dispersant; a polymer including a maleic anhydride moiety; and an electroactive material.

In another aspect, the invention features a battery, e.g., a lithium ion battery, including the electrode as disclosed.

Embodiments of one or more aspects may include one or more of the following features. The carbonaceous particles are selected from the group consisting of carbon black, graphite, acetylene black, graphenes, graphenes-related materials, carbon nanotubes, carbon nanostructures, activated carbons, carbon aerogels, templated carbons, and carbon fibers. The carbonaceous particles include carbon black. The carbon black has an oil adsorption number greater than 200 mL/100 g. The carbon black has a surface energy of greater than 18 mJ/m², for example, 18 to 30 mJ/m². The carbon black has a surface energy of less than 10 mJ/m². The composition includes 3 wt % to 25 wt % of the carbonaceous particles. The dispersant includes a cellulosic material. The dispersant is selected from the group consisting of methyl cellulose, ethyl cellulose, carboxymethyl cellulose, and succinylated ethyl cellulose. The composition includes at least 10% by weight of the dispersant relative to the carbon particles. The polymer has a molecular weight of at least 1,000 Daltons. The polymer is selected from the group consisting of poly(methyl vinyl ether maleic anhydride), poly(isobutylene maleic anhydride), poly(ethylene maleic anhydride), and poly(styrene-co-maleic anhydride). The composition includes at least 0.1 wt % of the polymer relative to the total composition. The carbonaceous material includes carbon black, the dispersant includes a cellulosic dispersant, and the solvent includes N-methylpyrrolidone. The composition has a viscosity of at least 500 cP at shear rate of 0.1 s⁻¹. The composition further includes a lithium-transition-metal-oxide electroactive material and/or a binder. The composition consists essentially of the carbonaceous particles, the dispersant, the polymer including a maleic anhydride moiety, and the solvent. The second composition further includes a binder.

In another aspect, the invention features a composition, including carbon black particles, a polymer comprising a maleic anhydride moiety, and a solvent.

Embodiments of one or more aspects may include one or more of the following features. The carbon black has an oil adsorption number greater than 200 mL/100 g. The carbon black has a surface energy of greater than 18 mJ/m², preferably 18 to 30 mJ/m². The carbon black has a surface energy of less than 10 mJ/m². The composition has a viscosity at least 500 cP at shear rate of 0.1 s⁻¹. The composition further includes a lithium-transition-metal-oxide electroactive material and/or a binder. The polymer has a molecular weight of at least 1,000 Daltons. The polymer is selected from the group consisting of poly(methyl vinyl ether maleic anhydride), poly(isobutylene maleic anhydride), poly(ethylene maleic anhydride), and poly(styrene-co-maleic anhydride). The solvent includes N-methylpyrrolidone. The composition consists essentially of the carbon particles, the polymer, and the solvent.

Other aspects, features, and advantages of the invention will be apparent from the description of the embodiments thereof and from the claims.

### BRIEF DESCRIPTION OF THE DRAWINGS

FIG. 1 is a plot of viscosity as a function of shear rate measured at 25° C. for Dispersion A (solid circle), Dispersion B (cross), Dispersion C (hollow square) and Dispersion D (solid diamond).

FIG. 2 is a plot of capacity retention of coin cells with cathodes made with Dispersion B (solid circle) and Dispersion D (hollow square). The solid and dashed lines show the average capacity retention of Dispersions B and D, respectively.

FIG. 3 is a plot of viscosity as a function of shear rate measured at 25° C. for Slurry 1, Slurry 2 and Slurry 3 from Example 7 and 8.

### DETAILED DESCRIPTION OF THE EMBODIMENTS

Described below are compositions that can be used to produce electrodes for batteries (e.g., lithium ion batteries), methods of making the compositions, and applications of the compositions in batteries.

In some embodiments, the compositions include carbonaceous particles that serve as a conductive additive, one or more dispersants, a polymer including a maleic anhydride moiety, and a solvent. In other embodiments, the compositions further include one or more co-dispersants. The compositions can be combined with an electroactive material, with or without a binder, to form electrode compositions. The electrode compositions can be applied to a conductive substrate to form electrodes (e.g., cathodes) of batteries.

The carbonaceous particles can include any particles consisting essentially of or containing carbon or its compounds and capable of enhancing the electrical conductivity of the electrode compositions. Examples of carbonaceous particles include carbon black, graphite, acetylene black, graphenes, graphenes-related materials (such as graphene oxides (GOs) and reduced graphene oxides (rGOs), carbon nanotubes, carbon nanostructures, activated carbons, carbon aerogels, templated carbons, and carbon fibers (such as vapor grown carbon nanofibers). Graphenes and graphenes-related materials (such as graphene oxides and reduced graphene oxides) are described, for example, in U.S. Patent Application Publication 2018-0021499, WO 2017/139115; and U.S. Provisional Patent Application No. 62/566,685. Carbon nanostructures are described, for example, in U.S. Patent Application Publication 2013-0071565; U.S. Pat. Nos. 9,133,031; 9,447,259; and 9,111,658. Examples of commercially-available carbonaceous particles include LITX® 50, LITX® 200, LITX® 300 and LITX® HP carbon black particles available from Cabot Corporation; graphenes and graphenes-related materials from Cabot Corporation; acetylene black under the product names Denka Li-400 and Li-435 from Denka; carbon black under the product names Ketjenblack EC300J and EC600JD from Lion Specialty Chemicals Co., Ltd.; and carbon black under the product name Super P® from Timcal. The compositions can include only one type of carbonaceous particles (e.g., carbon black particles only) or multiple types of carbonaceous particles as conductive additives (e.g., a blend of carbon black particles and carbon nanotubes).

In certain embodiments, the carbonaceous particles include carbon black particles having relatively high structure or volume-occupying properties, as indicated by their oil absorption numbers (OANs). For a given mass, high structure carbon black particles can occupy more volume than other carbon black particles having lower structures. When used as a conductive additive in a battery electrode, carbon black particles having relatively high OANs can provide a continuously electrically-conductive network (i.e., percolate) throughout the electrode at relatively lower loadings. Consequently, more electroactive material can be used, thereby improving the performance of the battery. In some embodiments, the carbon black particles have OANs greater than 200 mL/100 g, for example, ranging from 200 to 350 mL/100 g, or 200 to 250 mL/100 g. The OANs can have or include, for example, one of the following ranges: from 200 to 330 mL/100 g, or from 200 to 310 mL/100 g, or from 200 to 290 mL/100 g, or from 200 to 270 mL/100 g, or from 200 to 250 mL/100 g, or from 220 to 350 mL/100 g, or from 220 to 330 mL/100 g, or from 220 to 310 mL/100 g, or from 220 to 290 mL/100 g, or from 220 to 270 mL/100 g, or from 240 to 350 mL/100 g, or from 240 to 330 mL/100 g, or from 240 to 310 mL/100 g, or from 240 to 290 mL/100 g, or from 260 to 350 mL/100 g, or from 260 to 330 mL/100 g, or from 260 to 310 mL/100 g, or from 280 to 350 mL/100 g, or from 280 to 330 mL/100 g, or from 300 to 350 mL/100 g. Other ranges within these ranges are possible. All OAN values disclosed herein are determined by the method described in ASTM D 2414-16.

In some embodiments, independent of or in addition to having the structure described above, the carbon black particles have a high degree of graphitization, which can be indicated by lower surface energy values that can be associated with lower amounts of residual impurities on the surface of carbon black particles, and thus, their hydrophobicity. Without being bound by theory, it is believed that, up to a threshold purity level, purer particles can provide improved electrical conductivity and reduced likelihood of side reactions, thereby improving the performance of the particles. Surface energy can be measured by Dynamic Vapor (Water) Sorption (DVS) or water spreading pressure (described below). In some embodiments, the carbon black has a surface energy (SE) less than or equal to 10 mJ/m², e.g., from the detection limit (about 2 mJ/m²) to 10 mJ/m². The surface energy can have or include, for example, one of the following ranges: from the detection limit to 8 mJ/m², or from the detection limit to 7 mJ/m², or from the detection limit to 6 mJ/m², or from the detection limit to 5 mJ/m², or from the detection limit to 4 mJ/m². In certain embodiments, the surface energy, as measured by DVS, is less than 8 mJ/m², or less than 7 mJ/m², or less than 6 mJ/m², or less than 5 mJ/m², or less than 4 mJ/m², or at the detection limit. Other ranges within these ranges are possible.

In other embodiments, independent of or in addition to having the structure described above, the carbon black particles have a relatively low degree of graphitization, which can be indicated by higher surface energy values. Without being bound by theory, it is believed that, certain carbon black particles with high surface energy values may require less dispersant and/or different dispersants, which may provide performance and/or cost benefits. But carbon black particles with higher surface energies can increase the viscosities of the compositions containing the particles. In some embodiments, the carbon black has a surface energy, as measured by DVS, greater than or equal to 18 mJ/m², e.g., from 18 mJ/m² to 30 mJ/m². The surface energy can have or include, for example, one of the following ranges: from 18 mJ/m² to 28 mJ/m², or from 18 mJ/m² to 26 mJ/m², or from 18 mJ/m² to 24 mJ/m², or from 18 mJ/m² to 22 mJ/m², or from 20 mJ/m² to 30 mJ/m², or from 20 mJ/m² to 28 mJ/m², or from 20 mJ/m² to 26 mJ/m², or from 20 mJ/m² to 24 mJ/m², or from 22 mJ/m² to 30 mJ/m², or from 22 mJ/m² to 28 mJ/m², or from 22 mJ/m² to 26 mJ/m², or from 24 mJ/m² to 30 mJ/m², or from 24 mJ/m² to 28 mJ/m², or from 26 mJ/m² to 30 mJ/m². In certain embodiments, the surface energy, as measured by DVS, is less than 30 mJ/m², or less than 28 mJ/m², or less than 26 mJ/m², or less than 24 mJ/m², or less than 22 mJ/m². Other ranges within these ranges are possible.

Water spreading pressure is a measure of the interaction energy between the surface of carbon black (which absorbs no water) and water vapor. The spreading pressure is measured by observing the mass increase of a sample as it adsorbs water from a controlled atmosphere. In the test, the relative humidity (RH) of the atmosphere around the sample is increased from 0% (pure nitrogen) to about 100% (water-saturated nitrogen). If the sample and atmosphere are always in equilibrium, the water spreading pressure (no) of the sample is defined as:

$${π}_{e} = \frac{RT}{A} {\int }_{o}^{{P}_{o}} Γ d ln P$$

where R is the gas constant, T is the temperature, A is the BET surface area of the sample as described herein, Γ is the amount of adsorbed water on the sample (converted to moles/gm), P is the partial pressure of water in the atmosphere, and Pₒ is the saturation vapor pressure in the atmosphere. In practice, the equilibrium adsorption of water on the surface is measured at one or (preferably) several discrete partial pressures and the integral is estimated by the area under the curve.

The procedure for measuring the water spreading pressure is detailed in “Dynamic Vapor Sorption Using Water, Standard Operating Procedure”, rev. Feb. 8, 2005 (incorporated in its entirety by reference herein), and is summarized here. Before analysis, 100 mg of the carbon black to be analyzed was dried in an oven at 125° C. for 30 minutes. After ensuring that the incubator in the Surface Measurement Systems DVS1 instrument (supplied by SMS Instruments, Monarch Beach, Calif.) had been stable at 25° C. for 2 hours, sample cups were loaded in both the sample and reference chambers. The target RH was set to 0% for 10 minutes to dry the cups and to establish a stable mass baseline. After discharging static and taring the balance, approximately 10-12 mg of carbon black was added to the cup in the sample chamber. After sealing the sample chamber, the sample was allowed to equilibrate at 0% RH. After equilibration, the initial mass of the sample was recorded. The relative humidity of the nitrogen atmosphere was then increased sequentially to levels of approximately 0, 5, 10, 20, 30, 40, 50, 60, 70, 80, 90, and 95% RH, with the system allowed to equilibrate for 20 minutes at each RH level. The mass of water adsorbed at each humidity level was recorded, from which water spreading pressure was calculated (see above). The measurement was done twice on two separate samples and the average value is reported.

In various embodiments, the carbon black particles are heat-treated carbon black particles. “Heat-treated carbon black particles” are carbon black particles that have undergone a “heat treatment,” which as used herein, generally refers to a post-treatment of base carbon black particles that had been previously formed, e.g., by a furnace black process. The heat treatment can occur under inert conditions (i.e., in an atmosphere substantially devoid of oxygen), and typically occurs in a vessel other than that in which the base carbon black particles were formed. Inert conditions include, but are not limited to, a vacuum, and an atmosphere of inert gas, such as nitrogen, argon, and the like. In some embodiments, the heat treatment of carbon black particles under inert conditions is capable of reducing the number of impurities (e.g., residual oil and salts), defects, dislocations, and/or discontinuities in carbon black crystallites and/or increase the degree of graphitization.

The heat treatment temperatures can vary. In various embodiments, the heat treatment (e.g., under inert conditions) is performed at a temperature of at least 1000° C., or at least 1200° C., or at least 1400° C., or at least 1500° C., or at least 1700° C., or at least 2000° C. In some embodiments, the heat treatment is performed at a temperature ranging from 1000° C. to 2500° C., e.g., from 1400° C. to 1600° C. Heat treatment performed at a temperature refers to one or more temperatures ranges disclosed herein, and can involve heating at a steady temperature, or heating while ramping the temperature up or down, either stepwise and/or otherwise.

The heat treatment time periods can vary. In certain embodiments, the heat treatment is performed for at least 15 minutes, e.g., at least 30 minutes, or at least 1 hour, or at least 2 hours, or at least 6 hours, or at least 24 hours, or any of these time periods up to 48 hours, at one or more of the temperature ranges disclosed herein. In some embodiments, the heat treatment is performed for a time period ranging from 15 minutes to at least 24 hours, e.g., from 15 minutes to 6 hours, or from 15 minutes to 4 hours, or from 30 minutes to 6 hours, or from 30 minutes to 4 hours.

Generally, the heat treatment is performed until one or more desired properties of the carbon black particles (e.g., surface energy) are produced. As an example, during initial periods of heat treatment, test samples of heat treated particles can be removed, and their surface energies can be measured. If the measured surface energies are not as desired, then various heat treatment process parameters (such as heat treatment temperature and/or residence time) can be adjusted until the desired surface energy is produced.

In various embodiments, independent of or in addition to having the structure, surface energy and/or oxygen content described herein, the carbon black particles have a wide range of Brunauer-Emmett-Teller (BET) total surface areas. Without being bound by theory, it is believed that, during use of a battery, there are chemical side reactions that can occur within the battery that degrade its performance. Having particles with lower surface areas can enhance the performance of the battery by providing fewer surface sites where these unwanted side reactions can occur. However, the surface areas of the particles should be balanced, i.e., high enough, so that the particles can sufficiently cover and/or bridge the electroactive material and provide the desired electrode conductivity. In some embodiments, the carbon black particles have a BET surface area ranging from 30 to 1400 m²/g. The BET surface area can have or include, for example, one of the following ranges: from 30 to 1300 m²/g, or from 30 to 1200 m²/g, or from 30 to 1100 m²/g, or from 30 to 1000 m²/g, or from 30 to 900 m²/g, or from 30 to 800 m²/g, or from 30 to 700 m²/g, or from 30 to 600 m²/g, or from 30 to 500 m²/g, or from 30 to 400 m²/g, or from 30 to 300 m²/g, or from 30 to 150 m²/g, or from 50 to 150 m²/g, or from 200 to 1400 m²/g, or from 200 to 1300 m²/g, or from 200 to 1200 m²/g, or from 200 to 1100 m²/g, or from 200 to 1000 m²/g, or from 200 to 900 m²/g, or from 200 to 800 m²/g, or from 200 to 700 m²/g, or from 200 to 600 m²/g, or from 200 to 500 m²/g, or from 200 to 400 m²/g, or from 300 to 1400 m²/g, or from 300 to 1300 m²/g, or from 300 to 1200 m²/g, or from 300 to 1100 m²/g, or from 300 to 1000 m²/g, or from 300 to 900 m²/g, or from 300 to 800 m²/g, or from 300 to 700 m²/g, or from 300 to 600 m²/g, or from 300 to 500 m²/g, or from 400 to 1400 m²/g, or from 400 to 1300 m²/g, or from 400 to 1200 m²/g, or from 400 to 1100 m²/g, or from 400 to 1000 m²/g, or from 400 to 900 m²/g, or from 400 to 800 m²/g, or from 400 to 700 m²/g, or from 400 to 600 m²/g, or from 500 to 1400 m²/g, or from 500 to 1300 m²/g, or from 500 to 1200 m²/g, or from 500 to 1100 m²/g, or from 500 to 1000 m²/g, or from 500 to 900 m²/g, or from 500 to 800 m²/g, or from 500 to 700 m²/g, or from 600 to 1400 m²/g, or from 600 to 1300 m²/g, or from 600 to 1200 m²/g, or from 600 to 1100 m²/g, or from 600 to 1000 m²/g, or from 600 to 900 m²/g, or from 600 to 800 m²/g, or from 700 to 1400 m²/g, or from 700 to 1300 m²/g, or from 700 to 1200 m²/g, or from 700 to 1100 m²/g, or from 700 to 1000 m²/g, or from 700 to 900 m²/g, or from 800 to 1400 m²/g, or from 800 to 1300 m²/g, or from 800 to 1200 m²/g, or from 800 to 1100 m²/g, or from 800 to 1000 m²/g, or from 900 to 1400 m²/g, or from 900 to 1300 m²/g, or from 900 to 1200 m²/g, or from 900 to 1100 m²/g. Other ranges within these ranges are possible. All BET surface area values disclosed herein refer to BET nitrogen surface area and are determined by ASTM D6556-10, the entirety of which is incorporated herein by reference.

In some embodiments, independent of or in addition to having the structure, surface energy and/or BET surface area described herein, the carbon black particles have a relatively low oxygen content, which can be indicative of the particles' purity and electrical conductivity properties. In some embodiments, the carbon black has an oxygen content of less than or equal to 3 wt %, or less than or equal to 1.0 wt %, or less than or equal to 0.8 wt %, or less than or equal to 0.6 wt %%, or less than or equal to 0.4 wt %, or less than or equal to 0.06 wt %%, or less than or equal to 0.03 wt %%. The oxygen content can have or include, for example, one of the following ranges: from 0.001 to 3 wt %, or from 0.001 to 2 wt %, or from 0.001 to 1 wt %, or from 0.01 to 3 wt %, or from 0.01 to 2 wt %, or from 0.01 to 1 wt %, or from 0.01 to 0.8 wt %, or from 0.01 to 0.6 wt % or from 0.01 to 0.4 wt %. The oxygen content can be determined by inert gas fusion in which a sample of carbon black particles are exposed to very high temperatures (e.g., about 3000° C.) under inert gas conditions. The oxygen in the sample reacts with carbon to form CO and CO₂, which can be monitored by a non-dispersive infrared technique. The total oxygen content is reported in weight percent relative to the total weight of the sample. Various oxygen analyzers based on the inert gas fusion methods are known in the art and commercially available, for example a LECO® TCH600 analyzer.

The concentrations of the carbonaceous particles in the compositions can vary, depending on the specific type(s) of carbonaceous particles, and the specific type(s) and concentrations of the dispersant, the polymer, and the solvent. In some embodiments, the compositions include greater than 0.1 wt %, e.g., from 0.1 wt % to 30 wt %, of carbonaceous particles. As examples, the compositions can include 1 wt % to 30 wt % of carbon black particles, or 0.1 wt % to 15 wt % of carbon nanotubes and/or carbon nanostructures.

The dispersant generally includes a material capable of facilitating the dispersion of the carbonaceous material in the solvent (e.g., via a steric hindrance mechanism and/or an electrostatic charge mechanism), while keeping the viscosity of the compositions sufficiently low to enable practical processing of the compositions for manufacturing of electrodes for batteries. In some embodiments, the compositions including the carbonaceous particles, the dispersant(s), the co-dispersant(s), the polymer and the solvent have a viscosity of equal to or less than 200,000 cP at a shear rate of 0.1 s⁻¹, for example, at least 500 cP at a shear rate of 0.1 s⁻¹ at a shear rate of 0.1 s⁻¹, as determined at 25° C. using a TA AR2000ex Rheometer with a serrated plate geometry as described in Example 1. The viscosity at a shear rate of 0.1 s⁻¹ can have or include, for example, one of the following ranges: from 10,000 cP to 150,000 cP; or from 10,000 cP to 140,000 cP; or from 10,000 cP to 120,000 cP; or from 10,000 cP to 100,000 cP; or from 10,000 cP to 90,000 cP; or from 10,000 cP to 80,000 cP; or from 10,000 cP to 70,000 cP; or from 10,000 cP to 60,000 cP; or from 10,000 cP to 50,000 cP; or from 10,000 cP to 40,000 cP; or from 10,000 cP to 30,000 cP; or from 10,000 cP to 20,000 cP; or from 30,000 cP to 150,000 cP; or from 30,000 cP to 130,000 cP; or from 30,000 cP to 110,000 cP; or from 30,000 cP to 90,000 cP; or from 30,000 cP to 70,000 cP; or from 30,000 cP to 50,000 cP; or from 50,000 cP to 150,000 cP; or from 50,000 cP to 130,000 cP; or from 50,000 cP to 110,000 cP; or from 50,000 cP to 90,000 cP; or from 50,000 cP to 70,000 cP; or from 70,000 cP to 150,000 cP; or from 70,000 cP to 130,000 cP; or from 70,000 cP to 110,000 cP; or from 70,000 cP to 90,000 cP; or from 90,000 cP to 150,000 cP; or from 90,000 cP to 130,000 cP; or from 90,000 cP to 110,000 cP; or from 110,000 cP to 150,000 cP; or from 110,000 cP to 150,000 cP; or from 110,000 cP to 130,000 cP; or from 130,000 cP to 150,000 cP.

In various embodiments, the compositions can be described as a slurry or a paste that can be readily applied or coated to a conductive substrate to form an electrode, as contrasted with a mud that is too thick or viscous to be efficiently applied during manufacturing. In addition to its ability to disperse the carbonaceous particles, the dispersant preferably is thermally stable, is electrochemically inert, and/or interferes minimally with the electrical conductivity of the carbonaceous particles. A thermally stable or non-volatile dispersant allows the solvent (e.g., N-methylpyrrolidone) to be removed and recycled during electrode manufacturing without removing and/or degrading the dispersant. “Electrochemically inert” means that the dispersant is stable during normal use of the battery (e.g., does not degrade or oxidize at or below the operating voltages of the battery) since such degradation can negatively affect the performance of the battery. Furthermore, since the dispersant coats at least portions of the carbonaceous particles to disperse the particles, the dispersant will interfere with or reduce the conductive contact surfaces available to the particles. It is preferable to select a dispersant that minimally interferes with the electrical conductivity of the carbonaceous particles. In embodiments in which the compositions further include one or more electroactive materials, the dispersant (e.g., succinylated ethyl cellulose) is capable of reducing phase separation and/or settling of the electroactive material, as illustrated below. Examples of dispersants include cellulosic dispersants, such as methyl cellulose, carboxymethyl cellulose, ethyl cellulose, hydroxymethyl cellulose, hydroxyethyl cellulose, hydroxypropyl cellulose, methylhydroxyethyl cellulose, methylhydroxypropyl cellulose, succinylated ethyl cellulose, succinylated methyl cellulose, succinylated hydroxymethyl cellulose, succinylated hydroxyethyl cellulose and succinylated hydroxypropyl cellulose, vinyl polymers such as polyvinyl butyral resins including Kuraray Mowital® B14S, B16H, BA 20 S, B 20 H, B30 H, B30 HH, B30 T, B45 H, B60 H, B60 HH, B60 T and B 75 H resins; Eastman Butvar® B-72, B-74, B-76, B-79, B-90 and B-98 products; polyvinyl pyrrolidone including Ashland PVP K-12, K-15, K-30, K-60, K-90 and K-120 products, polyvinyl caprolactam, polyvinyl pyrrolidone copolymers such as polyvinyl pyrrolidone-co-vinyl acetate, butylated polyvinyl pyrrolidone such as Ganex™ P-904LC polymer, polyvinylpolypyrrolidone, polyvinylpyrrolidone-co-dimethylaminopropylmethacrylamide, polyvinylpyrrolidone-co-dimethylaminoethylmethacrylate, maleic imide copolymers such as isobutylene-ethylmaleimide-hydroxyethylmaleimide copolymer (Aquflex™ FX-64 product), Croda Hypermer™ KD-1, CrystaSense™ HP5, CrystaSense™ MP products, DisperBYK-2013, 2150, 2152, 2155 and 2200 products, poly(acrylonitrile-co-butadiene), dicarboxy terminated poly(acrylonitrile-co-butadiene), Zeon BM520B, BM720H and BM730H products. The compositions can include one composition of dispersants or multiple, different compositions of dispersants.

The co-dispersant is capable of reducing viscosity and stabilizing a dispersion, e.g., by preventing the dispersion from forming a gel. Examples of co-dispersants include monofunctional molecules with a boiling point lower than 200° C.,

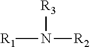

where R₁, R₂ and R₃ can independently be hydrogen or an alkyl group such as —CH₃, —C₂H₅ and —C₃H₇, and least one from R₁, R₂ and R₃ is an alkyl group; cyclic amino-based molecules with a boiling point lower than 200° C. such as piperidine and N-methyl piperidine; bifunctional molecules with a hydroxy and an amino group that possess a boiling point lower than 200° C.,

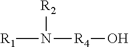

where R₁ and R₂ can independently be hydrogen or an alkyl group such as —CH₃, —C₂H₅ and —C₃H₇, and R₄ is an alkyl group such as —CH₂, —C₂H₄ and —C₃H₆; bifunctional molecules with two amino groups

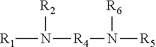

where R₁ and R₂ can independently be hydrogen or an alkyl group such as —CH₃, —C₂H₅ and —C₃H₇, R₄ is a alkyl group such as —CH₂, —C₂H₄ and —C₃H₆, and R₅ and R₆ can independently be hydrogen or a alkyl group such as —CH₃, —C₂H₅ and —C₃H₇. The compositions can include one composition of co-dispersants or multiple, different compositions of co-dispersants.

The total concentration of the dispersant(s) and/or the co-dispersant(s), if present, in the compositions can vary, depending on the composition(s) of the dispersant(s) and/or the co-dispersant(s) used, and the specific type(s) and concentrations of carbonaceous particles, the polymer, and the solvent. In some embodiments, the concentration of the dispersant(s) and/or the co-dispersant(s) is best expressed as a ratio of the dispersant(s) and/or the co-dispersant(s) to the carbonaceous particles, by weight. The weight ratio of the dispersant(s) and/or the co-dispersant(s) to carbonaceous particles can range from 1:100 to 50:100. The weight ratio of the dispersant(s) and/or the co-dispersant(s) to carbonaceous particles can have or include, for example, one of the following ranges: 1:100 to 40:100, or 1:100 to 30:100, or 1:100 to 20:100, or 1:100 to 10:100, or 10:100 to 50:100, or 10:100 to 40:100, or 10:100 to 30:100, or 10:100 to 20:100, or 20:100 to 50:100, or 20:100 to 40:100, or 20:100 to 30:100, or 30:100 to 50:100, or 30:100 to 40:100, or 40:100 to 50:100.

Turning now to the polymer including a maleic anhydride moiety, or a maleic anhydride-derived polymer, it is believed that the polymer is capable of trapping water formed during cycling of the battery and creating lithium ion channels, both of which are believed to enhance battery performance (e.g., by increasing cycle life and/or improving capacity retention). The polymer generally has the structure:

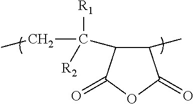

where R1 is an alkylether group, R2 is hydrogen, etc. In some embodiments, the polymer has a number average molecular weight ranging from 1,000 Daltons to 700,000 Daltons. Examples of the polymers include poly(ethylene maleic anhydride), poly(isobutylene maleic anhydride), poly(methyl vinyl ether maleic anhydride), poly(octadecene maleic anhydride), poly(maleic anhydride), poly(propylene maleic anhydride), polyisoprene-graft-maleic anhydride, poly(vinyl acetate maleic anhydride) and poly(styrene-co-maleic anhydride). The compositions can include one composition of maleic anhydride-derived polymer or multiple, different compositions of maleic anhydride-derived polymers.

The concentration of the maleic anhydride-derived polymer in the compositions can vary, depending on the composition(s) of the polymer used, and the specific type(s) and concentrations of carbonaceous particles, the dispersant(s), the co-dispersant(s), and the solvent. In some embodiments, the compositions include from 0.1 wt % to 5.0 wt % of the polymer. The concentration of the polymer in the compositions can have or include, for example, one of the following ranges: 0.1 wt % to 4 wt %, or 0.1 wt % to 3 wt %, or 0.1 wt % to 2 wt %%, or 0.1 wt % to 1 wt %, or 1 wt % to 5 wt %, or 1 wt % to 4 wt %, or 1 wt % to 3 wt %, or 1 wt % to 2 wt %, or 2 wt % to 5 wt %, or 2 wt % to 4 wt %, or 2 wt % to 3 wt %, or 3 wt % to 5 wt %, or 3 wt % to 4 wt %, or 4 wt % to 5 wt %. In various embodiments, the concentration of the polymer is expressed as a ratio of the dispersant to the carbonaceous particles by weight. The weight ratio of polymer to carbonaceous particles can range from 0.1:100 to 25:100. The weight ratio of polymer to carbonaceous particles can have or include, for example, one of the following ranges: 0.1:100 to 20:100, or 0.1:100 to 15:100, or 0.1:100 to 10:100, or 0.1:100 to 5:100, or 5:100 to 25:100, or 5:100 to 20:100, or 5:100 to 15:100, or 5:100 to 10:100, or 10:100 to 25:100, or 10:100 to 20:100, or 10:100 to 15:100, or 15:100 to 25:100, or 15:100 to 20:100, or 20:100 to 25:100.

The solvent can be any liquid that is suitable for use with the constituents of the compositions described herein and capable of being used to manufacture the intended electrode. The solvent can be anhydrous, polar and/or aprotic. In some embodiments, the solvent has a high volatility so that, during manufacturing, it can be easily removed (e.g., evaporated), thereby reducing drying time and production costs. Exemplary solvents include, e.g., N-methylpyrrolidone (NMP), acetone, alcohols, and water.

Methods of making the compositions generally include combining the constituents of compositions and forming a homogenous mixture (e.g., by blending). The methods are not particularly limited to any particular order of adding the individual constituents of the compositions or any particular method of mixing. As one example, the dispersant and the carbonaceous particles are mixed in the solvent to form a dispersion, and the maleic anhydride-derived polymer is subsequently added to the dispersion.

The compositions can be used in the production of a variety of energy storage devices, such as lithium-ion batteries. As an example, the compositions can be used to produce a cathode composition for a lithium-ion battery. The cathode composition typically includes a mixture including the compositions described herein, one or more electroactive materials, and optionally, a binder.

As used herein, an “electroactive material” means a material capable of undergoing reversible, Faradaic and/or capacitive electrochemical reactions. In some embodiments, the electroactive material is a lithium ion-based compound. Electroactive materials are described in, for example, Manthiram, ACS Cent. Sci. 2017, 3, 1063-1069; and Korthauer, Lithium-Ion Batteries: Basics and Applications, Springer Berlin Heidelberg, Feb. 14, 2018. Exemplary electroactive materials include those selected from at least one of:
LiMPO₄, wherein M represents one or more metals selected from Fe, Mn, Co, and Ni;
LiM′O₂, wherein M′ represents one or more metals selected from Ni, Mn, Co, Al, Mg, Ti, V, Cr, Fe, Zr, Ga, and Si;
Li(M″)₂O₄, wherein M″ represents one or more metals selected from Ni, Mn, Co, Al, Mg, Ti, V, Cr, Fe, Zr, Ga, and Si (e.g., Li[Mn(M″)]₂O₄); and
Li₁₊ₓ(Ni_{y}Co_{1-y-z}Mn_{z})₁₋ₓO₂, wherein x ranges from 0 to 1, y ranges from 0 to 1 and z ranges from 0 to 1.

In certain embodiments, the electroactive material is selected from at least one of LiNiO₂; LiNiₓAl_{y}O₂ where x varies from 0.8-0.99, y varies from 0.01-0.2, and x+y=1; LiCoO₂ “LCO”; LiMn₂O₄; Li₂MnO₃; LiNi_{0.5}Mn_{1.5}O₄; LiFeₓMn_{y}Co_{z}PO₄ where x varies from 0.01-1, y varies from 0.01-1, z varies from 0.01-0.2, and x+y+z=1; and LiNi_{1-x-y}MnₓCo_{y}O₂, wherein x ranges from 0.01 to 0.99 and y ranges from 0.01 to 0.99.

In other embodiments, the electroactive material is selected from at least one of Li₂MnO₃; LiNi_{1-x-y}MnₓCo_{y}O₂ wherein x ranges from 0.01 to 0.99 and y ranges from 0.01 to 0.99; LiNi_{0.5}Mn_{1.5}O₄; Li₁₊ₓ(Ni_{y}Co_{1-y-z}Mn_{z})₁₋ₓO₂ (“NCM”), Li₁₊ₓ(Ni_{y}Co_{1-y-z}Al_{z})₁₋ₓO₂ (“NCA”, e.g., LiNi_{0.8}Co_{0.15}Al_{0.05}O₂), wherein x ranges from 0 to 1, y ranges from 0 to 1, and z ranges from 0 to 1; and layered-layered compositions containing at least one of an Li₂MnO₃ phase and an LiMn₂O₃ phase. Layered-layered compositions are described in, for example, West et al., Journal of Power Sources, 204 (2012) 200-204; and Kim et al., Journal of The Electrochemical Society, 160 (1) A31-A38 (2013).

In some embodiments, the electrode includes a mixture of active materials having a nickel-doped Mn spinel, and a layered-layered Mn rich composition. The nickel-doped Mn spinel can have the formula LiNi_{0.5}Mn_{1.5}O₄, and the layered-layered Mn rich composition can contain a Li₂MnO₃, a LiMn₂O₃ phase or mixtures having the formula xLi₂MnO₃.(1-x)LiMO₂ (M=Ni, Co, Mn), 0<x<1.

The concentration of electroactive material(s) in the cathode composition or the electrode can vary, depending on the particular type of energy storage device. In some embodiments, the electroactive material is present in the cathode composition in an amount of at least 80% by weight, relative to the total weight of the composition, e.g., an amount of at least 90%, or an amount ranging from 80% to 99%, or an amount ranging from 90% to 99% by weight, relative to the total weight of the composition. The electroactive material is typically in the form of particles. In some embodiments, the electroactive particles have a D₅₀ particle size distribution ranging from 100 nm to 30 μm, e.g., a D₅₀ ranging from 1-15 μm. In other embodiments, the electroactive particles have a D₅₀ ranging from 1-6 μm, e.g., from 1-5 μm.

In certain embodiments, the cathode composition further includes one or more binders to enhance the mechanical properties of the formed electrode. Exemplary binder materials include, but are not limited to, fluorinated polymers such as poly(vinyldifluoroethylene) (PVDF), poly(vinyldifluoroethylene-co-hexafluoropropylene) (PVDF-HFP), poly(tetrafluoroethylene) (PTFE), polyimides, polyacrylonitrile-based co-polymers such as polyacrylonitrile-co-butadiene and water-soluble binders such as poly(ethylene) oxide, polyvinyl-alcohol (PVA), cellulose, carboxymethylcellulose (CMC), starch, hydroxypropylcellulose, regenerated cellulose, polyvinyl pyrrolidone (PVP), and copolymers and mixtures thereof. Other possible binders include polyethylene, polypropylene, ethylene-propylene-diene terpolymer (EPDM), sulfonated EPDM, styrene-butadiene rubber (SBR), and fluoro rubber and copolymers and mixtures thereof. In some embodiments, the binder is present in the cathode composition in an amount of 1 to 10% by weight.

An electrode (e.g., cathode) composition can be made by homogeneously interspersing (e.g., by uniformly mixing) the compositions described herein with the electroactive material. In some embodiments, the binder is also homogeneously interspersed with the compositions described herein and electroactive material. The electrode composition can take the form of a paste or a slurry, in which particulate electroactive material, carbonaceous particles, dispersant(s), maleic anhydride-derived polymer(s), solvent, and binder (if present) are combined. The constituents of the electrode composition can be combined in any order so long as the resulting mixture is substantially homogeneous, which can be achieved by shaking, stirring, etc. In certain embodiments, the electrode composition is a solid resulting from solvent removal from the paste or slurry.

In some embodiments, an electrode is formed by depositing the paste onto an electrically conducting substrate (e.g., an aluminum current collector), followed by removing the solvent. In certain embodiments, the paste has a sufficiently high solids loading to enable deposition onto the substrate while minimizing the formation of inherent defects (e.g., cracking) that may result with a less viscous paste (e.g., having a lower solids loading). Moreover, a higher solids loading reduces the amount of solvent needed. The solvent is removed by drying the paste, either at ambient temperature or under low heat conditions, e.g., temperatures ranging from 20° to 100° C. The deposited cathode/current collector can be cut to the desired dimensions, optionally followed by calendering.

The formed electrode can be incorporated into a lithium-ion battery according to methods known in the art, for example, as described in “Lithium Ion Batteries Fundamentals and Applications,” by Yuping Wu, CRC press, (2015).

Other embodiments are also possible. For example, in certain embodiments, the compositions described herein consists of or consists essentially of (1) the carbonaceous particles as described herein, (2) one or more dispersants as described herein, (3) one or more co-dispersants as described herein, (4) one or more maleic anhydride-derived polymers as described herein, and (5) a solvent as described herein.

As another example, the compositions include (1) the carbonaceous particles as described herein, (2) one or more dispersants as described herein, (3) one or more co-dispersants as described herein, and (4) a solvent as described herein, i.e., the compositions do not include a maleic anhydride-derived polymer. These compositions can include 5 wt % to 25 wt % of carbonaceous particles, and 0.2 wt % to 5 wt % of the dispersant(s) and/or co-dispersant(s), relative to the entire compositions. These compositions can include a weight ratio of dispersant and/or co-dispersant to carbonaceous particles ranging from 3:100 to 50:100. The weight ratio of dispersant and/or co-dispersant to carbonaceous particles can have or include, for example, one of the following ranges: 3:100 to 40:100, or 3:100 to 30:100, or 3:100 to 20:100, or 3:100 to 10:100, or 10:100 to 50:100, or 10:100 to 40:100, or 10:100 to 30:100, or 10:100 to 20:100, or 20:100 to 50:100, or 20:100 to 40:100, or 20:100 to 30:100, or 30:100 to 50:100, or 30:100 to 40:100, or 40:100 to 50:100. These compositions can consist of or consist essentially of (1) the carbonaceous particles as described herein, (2) one or more dispersants and/or co-dispersants as described herein, and (3) a solvent as described herein.

As another example, the compositions include (1) the carbonaceous particles as described herein, (2) one or more maleic anhydride-derived polymers as described herein, and (3) a solvent as described herein, i.e., the compositions do not include a dispersant and/or a co-dispersant. These compositions can include 5 wt % to 25 wt % of carbonaceous particles, and 0.1 wt % to 10 wt % of the polymer(s), relative to the entire compositions. These compositions can include a weight ratio of polymer to carbonaceous particles ranging from 0.4:100 to 50:100. The weight ratio of polymer to carbonaceous particles can have or include, for example, one of the following ranges: 3:100 to 40:100, or 3:100 to 30:100, or 3:100 to 20:100, or 3:100 to 10:100, or 10:100 to 50:100, or 10:100 to 40:100, or 10:100 to 30:100, or 10:100 to 20:100, or 20:100 to 50:100, or 20:100 to 40:100, or 20:100 to 30:100, or 30:100 to 50:100, or 30:100 to 40:100, or 40:100 to 50:100. These compositions can consist of or consist essentially of (1) the carbonaceous particles as described herein, (2) one or more maleic anhydride-derived polymers as described herein, and (3) a solvent as described herein.

In other embodiments, the compositions described herein are used (e.g., incorporated) in electrodes of other energy storage devices, such as, primary alkaline batteries, primary lithium batteries, nickel metal hydride batteries, sodium batteries, lithium sulfur batteries, lithium air batteries, and supercapacitors. Methods of making such devices are known in the art and are described, for example, in “Battery Reference Book,” by TR Crompton, Newness (2000).

### EXAMPLES

### Example 1

Dispersion of a Conductive Carbon Additive Using Poly(Vinylpyrrolidone)

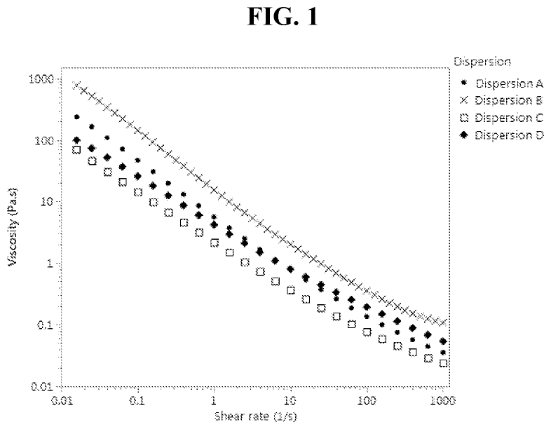

Prior to dispersion preparation, 6 grams of LITX® HP conductive carbon additive (CCA) (Cabot Corporation), pulverized by jet milling, were placed in a 100-ml container and dried in a vacuum oven at 100° C. for 16 hrs. A 10 wt % dispersant solution was made by dissolving 10 grams of poly(vinylpyrrolidone) (PVP, molecular weight 40,000 g/mol, Aldrich-Sigma) with 90 grams of n-methyl pyrrolidine (NMP) in a 500-ml beaker. Then, 8 grams of the 10 wt % PVP/NMP solution were transferred to 6 grams LITX® HP powder container together with 26 g of NMP. The resulting mixture was mixed in a planetary Thinky mixer with tungsten carbide media at a speed of 2,000 RPM for 12 minutes. The resulting dispersion composed of 15 wt % LITX® HP CCA and 2 wt % PVP is designated as Dispersion A. Rheology was measured at 25° C. using a TA AR2000ex Rheometer equipped with a 40 mm serrated steel plate geometry. Pre-shear is applied at a shear rate of 50 s⁻¹ for 30 seconds followed by stepped shear rate sweep from 0.01 s⁻¹ to 1000 s⁻¹. The results are shown in FIG. 1. A viscosity of 47,000 mPa·s from Dispersion A was recorded at a shear rate of 0.1 s⁻¹.

### Example 2

Dispersion of a Conductive Carbon Additive Using Ethyl Cellulose

A dispersion made with the same procedure as Example 1, except that ethyl cellulose (viscosity 4 cp, Dow Chemical) was used as the dispersant in place of PVP and the resulting composition was 20 wt % LITX® HP CCA with 2 wt % ethyl cellulose. The viscosity of this dispersion was 143,000 mPa·s at 0.1 s⁻¹ as shown in FIG. 1. This resulting dispersion is designated as Dispersion B.

### Example 3

Dispersion of a Conductive Carbon Additive Using Ethyl Cellulose

A dispersion was made using the same procedure as Example 2, except that the resulting composition included 15 wt % of LITX® HP carbon additive with 0.9 wt % of ethyl cellulose. The viscosity of this dispersion was 14,400 mPa·s at 0.1 s⁻¹ as shown in FIG. 1. This resulting dispersion is designated as Dispersion C.

### Example 4

Dispersion of a Conductive Carbon Additive Using Succinylated Ethyl Cellulose

Succinylated ethyl cellulose (SEC) was prepared as follows. In a 100-ml plastic container, 0.42 g ethyl cellulose (viscosity 4 cp, Dow Chemical) and 0.12 g succinic anhydride were mixed with 33.46 g of NMP solvent. This mixture was placed in a 60° C. oven for 16 hours. After cooling the mixture to ambient temperature, 6.0 grams of LITX® HP jet-milled conductive carbon additive were added into the mixture. The resulting mixture was mixed in a planetary Thinky mixer with tungsten carbide media at a speed of 2,000 RPM for 12 minutes. The viscosity of the dispersion was recorded as 15,180 mPa·s at a shear rate of 0.1 s⁻¹.

### Example 5

Dispersion of a Conductive Carbon Additive Using Mixture of Ethyl Cellulose and Succinic Anhydride

A dispersion was made using the same procedure as Example 4, except that the mixture of ethyl cellulose and succinic anhydride was not heated. The viscosity of the dispersion was recorded as 16,300 mPa·s at a shear rate of 0.1 s⁻¹.

### Example 6

Dispersion of a Conductive Carbon Additive Using Succinylated Ethyl Cellulose with Poly(Methyl Vinyl Ether-Alt-Maleic Anhydride)

Succinylated ethyl cellulose (SEC) was prepared using the same procedure as Example 4. In a 100-ml plastic container, 0.772 g succinylated ethyl cellulose was mixed with 32 g of NMP solvent, and then 7.2 grams of LITX® HP jet-milled conductive carbon additive were added into the mixture. The resulting mixture was mixed in a planetary Thinky mixer with tungsten carbide media at a speed of 2,000 RPM for 12 minutes. Then, 0.08 gram of poly(methyl vinyl ether-alt-maleic anhydride) (PMVEMA) was added into the resulting mixture and mixed in the Thinky mixer again at 2000 rpm for 1 minute. The viscosity of the dispersion was recorded as 25,800 mPa·s at 0.1 S⁻¹ shear rate as shown in FIG. 1. This resulting dispersion is designated as Dispersion D.

### Example 7

Dispersion of a Conductive Carbon Additive Using Polyvinyl Butyral (PVB).

A dispersion was made using the same procedure as Example 2, except that the resulting composition included 15 wt % of LITX® HP carbon additive with 1.0 wt % of PVB (Kuraray Mowital® B60 HH product). The viscosity of this dispersion was 21,700 mPa·s at 0.1 s⁻¹.

### Example 8

Dispersion of a Conductive Carbon Additive Using Croda Hypermer™ KD-1 Product as a Component.

A dispersion was made using the same procedure as Example 2, except that the resulting composition included 15 wt % of LITX® HP carbon additive with 0.6 wt % of ethyl cellulose and 0.6 wt % Croda Hypermer™ KD-1 product. The viscosity of this dispersion was 50,230 mPa·s at 0.1 s⁻¹ as shown in FIG. 1.

### Example 9

Dispersion of a Conductive Carbon Additive Using DisperBYK-2155 Dispersant as a Component.

A dispersion was made using the same procedure as Example 8, except that the resulting composition included 15 wt % of LITX® HP carbon additive with 0.6 wt % of ethyl cellulose and 0.6 wt % DisperBYK-2155 product. The viscosity of this dispersion was 49,900 mPa·s at 0.1 s⁻¹.

### Example 10

Dispersion of a Conductive Carbon Additive Using Ethyl Cellulose with DisperBYK-2155 Dispersant with Different Ratio.

Dispersions were made using the same procedure as Example 9, except that the resulting compositions included 15 wt % of LITX® HP carbon additive with 1.2 wt % of total dispersant loading with ethyl cellulose to DisperBYK-2155 dispersant ratios of 0.875 and 0.714, respectively. The viscosities of dispersions were 52,030 mPa·s at 0.1 s⁻¹ for dispersant ratio 0.875 and 103,500 mPa·s for dispersant ratio 0.714.

### Example 11

Dispersion of a Conductive Carbon Additive Using Croda CrystaSense™ HP5 Dispersant as a Component

A dispersion was made using the same procedure as Example 9, except that the resulting composition included 15 wt % of LITX® HP carbon additive with 0.6 wt % of ethyl cellulose and 0.6 wt % CrystaSense™ HP5 dispersant. The viscosity of this dispersion was 37,330 mPa·s at 0.1 s⁻¹.

### Example 12

Dispersion of a Conductive Carbon Additive Using CrystalSense™ MP Dispersant

A dispersion was made using the same procedure as Example 9, except that the resulting composition included 15 wt % of LITX® HP carbon additive with 0.6 wt % of ethyl cellulose and 0.6 wt % CrystaSense™ MP dispersant. The viscosity of this dispersion was 87,200 mPa·s at 0.1 s⁻¹.

### Example 13

Dispersion of a Conductive Carbon Additive Using N-Ethyl Isopropylamine as a Component.

A dispersion was made using the same procedure as Example 9, except that the resulting composition included 15 wt % of LITX® HP carbon additive with 0.6 wt % ethyl cellulose, 0.6 wt % DisperBYK-2155 dispersant and 0.05 wt % N-ethylisopropylamine. The viscosity of this dispersion was 24,790 mPa·s at 0.1 s⁻¹.

### Example 14

Dispersion of a Conductive Carbon Additive Using 1-Ethylpropylamine as a Component.

A dispersion was made using the same procedure as Example 14, except that the resulting composition included 0.05 wt % 1-ethylpropylamine instead of N-ethylisopropylamine. The viscosity of this dispersion was 17,190 mPa·s at 0.1 s⁻¹.

### Example 15

Dispersion of a Conductive Carbon Additive Using 2-amino-2-methyl-1-propanol as a Component.

A dispersion was made using the same procedure as Example 14, except that the resulting composition included 0.05 wt % 2-amino-2-methyl-1-propanol instead of N-ethylisopropylamine. The viscosity of this dispersion was 14,700 mPa·s at 0.1 s⁻¹.

### Example 16

Dispersion of a Conductive Carbon Additive Using N-Methylpiperidine as a Component

A dispersion was made using the same procedure as Example 14, except that the resulting composition included 0.05 wt % N-methylpiperidine instead of N-ethylisopropylamine. The viscosity of this dispersion was 33,520 mPa·s at 0.1 s⁻¹.

### Example 17

Dispersion of a Conductive Carbon Additive Using Dicarboxy-Terminated Poly(Acrylonitrile-Co-Butadiene) as a Component.

A dispersion was made using the same procedure as Example 9, except that the resulting composition included 12 wt % LITX HP with 0.6 wt % ethyl cellulose and 0.6 wt % dicarboxy-terminated poly(acrylonitrile-co-butadiene). The viscosity of this dispersion was 28,000 mPa·s at 0.1 s⁻¹

### Example 18

Dispersion of a Conductive Carbon Additive Using Zeon BM730H Dispersant as a Component.

A dispersion was made using the same procedure as Example 9, except that the resulting composition included 0.6 wt % Zeon BM730H dispersant instead of DisperBYK-2155 dispersant. The viscosity of this dispersion was 50,300 mPa·s at 0.1 s⁻¹.

### Example 19

Dispersion of a Conductive Carbon Additive Using Zeon BH730H Dispersant and 2-Amino-2-Methyl-1-Propanol as Components.

A dispersion was made using the same procedure as Example 18, except that the resulting composition included additional 0.05 wt % 2-amino-2-methyl-1-propanol. The viscosity of this dispersion was 21,700 mPa·s at 0.1 s⁻¹.

### Example 20

Cathode Slurry, Electrode Preparation and Coin Cell Assembly

A premixed 10 wt % PVDF/NMP solution was made by dissolving 10 g of PVDF (Kynar® HSV-900, Arkema) in 90 g of NMP solvent. Then, 3.2 g of the 10 wt % PVDF solution was transferred to 3.84 g of NMP solvent together with 1.6 g of Dispersion B made according to Example 2 in a plastic container. To ensure thorough mixing of the PVDF and LITX HP conductive carbon additive (CCA), the mixture was mixed in a planetary Thinky mixer with tungsten carbide media at a speed of 2,000 RPM for 12 minutes. Then 31.36 g of LiNi_{0.6}Co_{0.2}Mn_{0.2}O₂ (NCM 622) active material (Targray) was added to the premixed PVDF/LITX HP CCA/NMP mixture and mixed in the planetary Thinky mixer again at a speed of 2,000 RPM for 12 minutes. The well-mixed slurry was then cast onto an alumina foil using the doctor blade method and dried at 90° C. in a convection oven for 10 mins. By varying the height of the blade, all the electrode films were cast to have approximately the same loading of active material (approximately 30 mg/cm²). The oven-dried electrode sheet was then calendered to a thickness of 125 microns. The calendered electrode sheets were thoroughly dried at 100° C. under vacuum for 16 h before use.

Full coin cells were assembled with the above-mentioned cathode sheets and graphite anodes. The graphite anodes consisted of 95 wt % graphite, 4.5 wt % carboxy methylcellulose and styrene butadiene rubber as binders, and 0.5 wt % conductive carbon black. The capacity of the graphite anode per area was slightly higher than that of the cathode to prevent lithium deposition. The separator employed was Whatman glass fiber. The electrolyte used was 1M LiPF₆ in a mixture of ethylene carbonate/dimethyl carbonate/ethyl methyl carbonate in volumetric ratio of 1:1:1 with 1 wt % of vinylene carbonate.

Two formation cycles for the full cells were performed at C/5 to ensure complete formation of surface films for both the cathode and the anode. The charge voltage limit was set to 4.2 V, and the discharge voltage limit was 2.8 V vs Li/Li⁺. The nominal discharge capacity was used to estimate the capacity of the cells. Long-term cycling of the full cells was carried out with a 1 C charge to 4.3 V and followed by 1 C discharge to 2.7 V for 300 cycles.

### Example 21

Cathode Made with Dispersion D Showed Benefits Over Dispersion B in Terms of Cycle Life

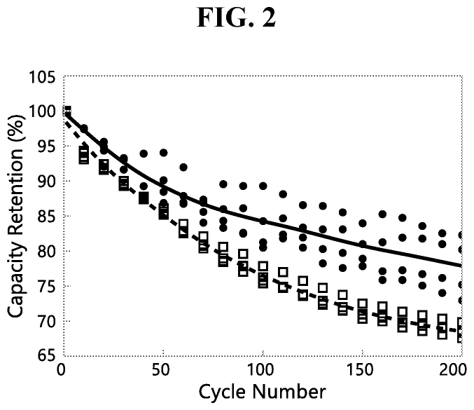

Cells made with Dispersion B and Dispersion D were tested for battery cycle performance as described in Example 5. During charge/discharge cycling tests, discharge capacity retention was determined from a ratio between the discharge capacity at the first cycle and at a specific cycle. The average capacity retention based on five cells made with Dispersion B was 75% at the 100th cycle, and 72% at the 200th cycle. A significant improvement was found at early cycling for the cells made with Dispersion D. At the 100th cycle, the average capacity retention of cells based on Dispersion D was 86%, and at 200 cycles, the average capacity retention maintained at 80%. (FIG. 2)

### Example 22

Cathode Slurry Settling

When formulating cathode slurries, it is desirable that they are shelf-stable for up to one week after initial production. Cathode slurries preferably exhibit minimal settling and a rheology that is conducive to quality coating. To improve processability, it is preferable to deliver the conductive carbon additive in the form of a dispersion containing dispersants. Cathode slurries made with dispersants can exhibit significant settling. Excessive settling can result in poor coating quality of electrodes. When settling occurs, the cathode slurry can separate into two distinct phases. The upper phase includes mainly of conductive carbon additive, PVDF and NMP. The lower phase includes active materials, conductive carbon additive, PVDF and NMP. There are distinct differences in the consistency of the two phases, with the upper phase being quite fluid and the lower phase showing a significant increase in viscosity.

Settling was measured by storing a portion of the cathode slurry for one week and then carefully collecting the top half of material using a syringe. Each portion is then thoroughly mixed and percent solids are measured. The difference in percent solids is preferably as low as possible. By looking at the rheology of the cathode slurry, insight into what causes settling can be gained. Due to the high density of active materials, it is desirable that the slurry exhibits high viscosity at low shear rates. High viscosity at low shear rates is effective at counteracting settling, as low shear rates are analogous to the effects of gravity on a substance. It is equally desirable that the cathode slurry exhibits low viscosity at high shear rates. If the slurry is too viscous at high shear rates, coating quality becomes an issue.

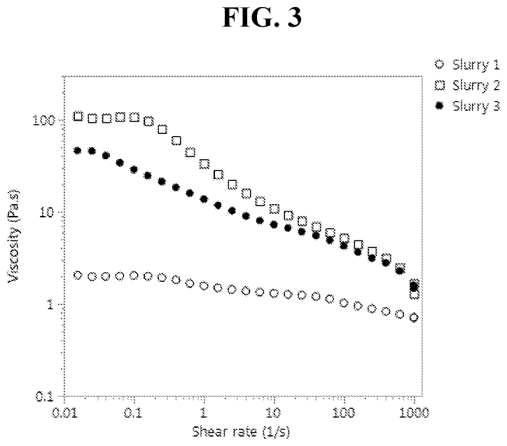

A cathode slurry was made with Dispersion B based on the slurry preparation method in Example 4, except the active material was LiNi_{0.8}Co_{0.1}Mn_{0.1}O₂ (NCM 811). The resulting slurry was designated as Slurry 1. The total solids were chosen to allow for a suitable viscosity for pasting cathodes, approximately 2,000-4,000 cP at 60 s⁻¹. Slurry 1 was stirred for 45 minutes with a high shear cowls blade at a tip speed of 0.997 m/s. 100 g of the slurry was stored in a sealed wide mouth 60 mL HDPE Nalgene bottle for one week at room temperature. After one week, the top 50% by weight was carefully removed with a syringe and placed in a separate 60 mL Nalgene bottle. Each portion was mixed in a vortex mixer for one minute. The solid content of each portion was measured by drying for two hours in a 150° C. oven. Settling was calculated by the difference between solid content at the bottom portion and solid content at the top portion. The shear rate-dependent viscosity curve of Slurry 1 is shown in FIG. 3. The viscosity at a shear rate of 60 S⁻¹ was 1050 cp. Slurry 1 showed settling of 11.9 wt %.

### Example 23

A cathode slurry was made based on the slurry preparation method in Example 6, except the dispersant used in the conductive carbon additive dispersion was the SEC described in Example 4. The resulting cathode slurry is designated as Slurry 2 (see FIG. 3), which showed a high viscosity of 6000 cp at a shear rate of 60 Using the settling measurement method in Example 7, Slurry 2 exhibited no settling.

A cathode slurry was made based on the same slurry preparation method, except the conductive carbon additive dispersion applied was Dispersion D, described in Example 4. The resulting cathode slurry is designated as Slurry 3, which showed a viscosity of 3000 cp at a shear rate of 60 s⁻¹ as shown in FIG. 3. Slurry 3 exhibited a very small amount of settling of 0.72%.

The use of the terms “a” and “an” and “the” is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All publications, applications, ASTM standards, and patents referred to herein are incorporated by reference in their entirety.

Still other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof

What is claimed is:

1. A composition, comprising:
carbonaceous particles;
a dispersant;
a polymer comprising a maleic anhydride moiety; and
a solvent.

2. The composition of claim 1, wherein the carbonaceous particles are selected from the group consisting of carbon black, graphite, acetylene black, graphenes, graphenes-related materials, carbon nanotubes, carbon nanostructures, activated carbons, carbon aerogels, templated carbons, and carbon fibers.

3. (canceled)

4. The composition of claim 1, wherein the carbonaceous particles comprise carbon black having an oil adsorption number greater than 200 mL/100 g.

5. (canceled)

6. (canceled)

7. The composition of claim 1, wherein the composition comprises 3 wt % to 25 wt % of the carbonaceous particles.

8-11. (canceled)

12. The composition of claim 1, wherein the polymer is selected from the group consisting of poly(methyl vinyl ether maleic anhydride), poly(isobutylene maleic anhydride), poly(ethylene maleic anhydride), and poly(styrene-co-maleic anhydride).

13-16. (canceled)

17. The composition of claim 1, further comprising a co-dispersant selected from the group consisting of monofunctional molecules with a boiling point lower than 200° C.; 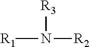
where R₁, R₂ and R₃ can independently be hydrogen or an alkyl group such as —CH₃, —C₂H₅ and —C₃H₇, and least one from R₁, R₂ and R₃ is an alkyl group; cyclic amino-based molecules with a boiling point lower than 200° C.; bifunctional molecules with a hydroxy and an amino group that possess a boiling point lower than 200° C.; 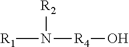
where R₁ and R₂ can independently be hydrogen or an alkyl group such as —CH₃, —C₂H₅ and —C₃H₇, and R₄ is an alkyl group such as —CH₂, —C₂H₄ and —C₃H₆; bifunctional molecules with two amino groups 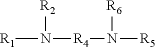
where R₁ and R₂ can independently be hydrogen or an alkyl group such as —CH₃, —C₂H₅ and —C₃H₇, R₄ is a alkyl group such as —CH₂, —C₂H₄ and —C₃H₆, and R₅ and R₆ can independently be hydrogen or a alkyl group such a s —CH₃, —C₂H₅ and —C₃H₇, and combinations thereof.

18. The composition of claim 1, wherein the dispersant is selected from the group consisting of methyl cellulose, carboxymethyl cellulose, ethyl cellulose, hydroxymethyl cellulose, hydroxyethyl cellulose, hydroxypropyl cellulose, methylhydroxyethyl cellulose, methylhydroxypropyl cellulose, succinylated ethyl cellulose, succinylated methyl cellulose, succinylated hydroxymethyl cellulose, succinylated hydroxyethyl cellulose and succinylated hydroxypropyl cellulose, polyvinyl butyral resins, polyvinyl pyrrolidone, polyvinyl caprolactam, polyvinyl pyrrolidone copolymers, butylated polyvinyl pyrrolidone, polyvinylpolypyrrolidone, polyvinylpyrrolidone-co-dimethylaminopropylmethacrylamide, polyvinylpyrrolidone-co-dimethylaminoethylmethacrylate, maleic imide copolymers, poly(acrylonitrile-co-butadiene), dicarboxy terminated poly(acrylonitrile-co-butadiene, and combinations thereof.

19-36. (canceled)

37. A method, comprising
combining an electroactive material with a first composition comprising carbonaceous particles, a dispersant, a polymer comprising a maleic anhydride moiety, and a solvent, to form a second composition; and
using the second composition to make an electrode.

38. (canceled)

39. (canceled)

40. The method of claim 37, wherein the carbonaceous particles are selected from the group consisting of carbon black, graphite, acetylene black, graphenes, graphenes-related materials, carbon nanotubes, carbon nanostructures, activated carbons, carbon aerogels, templated carbons, and carbon fibers.

41. (canceled)

42. The method of claim 37, wherein the carbonaceous particles comprise carbon black having an oil adsorption number greater than 200 mL/100 g.

43-49. (canceled)

50. The method of claim 37, wherein the polymer is selected from the group consisting of poly(methyl vinyl ether maleic anhydride), poly(isobutylene maleic anhydride), poly(ethylene maleic anhydride), and poly(styrene-co-maleic anhydride).

51-54. (canceled)

55. The method of claim 37, wherein the first composition further comprises a co-dispersant selected from the group consisting of monofunctional molecules with a boiling point lower than 200° C.; 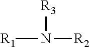
where R₁, R₂ and R₃ can independently be hydrogen or an alkyl group such as —CH₃, —C₂H₅ and —C₃H₇, and least one from R₁, R₂ and R₃ is an alkyl group; cyclic amino-based molecules with a boiling point lower than 200° C.; bifunctional molecules with a hydroxy and an amino group that possess a boiling point lower than 200° C.; 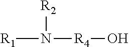
where R₁ and R₂ can independently be hydrogen or an alkyl group such as —CH₃, —C₂H₅ and —C₃H₇, and R₄ is an alkyl group such as —CH₂, —C₂H₄ and —C₃H₆; bifunctional molecules with two amino groups 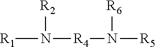
where R₁ and R₂ can independently be hydrogen or an alkyl group such as —CH₃, —C₂H₅ and —C₃H₇, R₄ is a alkyl group such as —CH₂, —C₂H₄ and —C₃H₆, and R₅ and R₆ can independently be hydrogen or a alkyl group such as —CH₃, —C₂H₅ and —C₃H₇, and combinations thereof.

56. The method of claim 37, wherein the dispersant is selected from the group consisting of methyl cellulose, carboxymethyl cellulose, ethyl cellulose, hydroxymethyl cellulose, hydroxyethyl cellulose, hydroxypropyl cellulose, methylhydroxyethyl cellulose, methylhydroxypropyl cellulose, succinylated ethyl cellulose, succinylated methyl cellulose, succinylated hydroxymethyl cellulose, succinylated hydroxyethyl cellulose and succinylated hydroxypropyl cellulose, polyvinyl butyral resins, polyvinyl pyrrolidone, polyvinyl caprolactam, polyvinyl pyrrolidone copolymers, butylated polyvinyl pyrrolidone, polyvinylpolypyrrolidone, polyvinylpyrrolidone-co-dimethylaminopropylmethacrylamide, polyvinylpyrrolidone-co-dimethylaminoethylmethacrylate, maleic imide copolymers, poly(acrylonitrile-co-butadiene), dicarboxy terminated poly(acrylonitrile-co-butadiene, and combinations thereof.

57-121. (canceled)
